(19) United States
(12) Patent Application Publication
(10) Pub. No.: US 2017/0288781 A1
(43) Pub. Date: Oct. 5, 2017

(54) HIGHER ORDER OPTICAL PAM MODULATION USING A MACH-ZEHNDER INTERFEROMETER (MZI) TYPE OPTICAL MODULATOR HAVING A BENT OPTICAL PATH

(71) Applicants: STMicroelectronics (Crolles 2) SAS, Crolles (FR); STMicroelectronics SA, Montrouge (FR)

(72) Inventors: Jean-Francois Carpentier, Grenoble (FR); Patrick Lemaitre, Biviers (FR); Jean-Robert Manouvrier, Echirolles (FR); Denis Pache, Grenoble (FR); Stephane Le Tual, St-Egreve (FR)

(73) Assignees: STMicroelectronics (Crolles 2) SAS, Crolles (FR); STMicroelectronics SA, Montrouge (FR)

(21) Appl. No.: 15/083,616

(22) Filed: Mar. 29, 2016

(51) Int. Cl. H04B 10/516; H04L 25/49

(52) U.S. Cl. CPC H04B 10/5161; H04L 25/4917

(57) ABSTRACT

An optical modulator includes an optical waveguide including at least a first PN junction phase shifter and a second PN junction phase shifter. A driver circuit drives operation of the first and second PN junction phase shifters in response to a pulse amplitude modulated (PAM) analog signal having 2ⁿ levels. The PAM analog signal is generated by a digital to analog converter that receives an n-bit input signal. In an implementation, the optical waveguide and PN junction phase shifters are formed on a first integrated circuit chip and the driver circuit is formed on a second integrated circuit chip that is stacked on and electrically connected to the first integrated circuit chip.

### TECHNICAL FIELD

The present invention relates to pulse amplitude modulation (PAM) and the generation of a multi-level amplitude modulated optical signal using an optical modulator of the Mach-Zehnder Interferometer (MZI) type.

### BACKGROUND

FIG. 1 shows a prior art Mach-Zehnder Interferometer (MZI) type optical modulator 10. The modulator 10 includes an input optical waveguide section 12 and an output optical waveguide section 14. A continuous wave (CW) light signal from a laser source 16 is coupled to the input optical waveguide section 12. An optical splitter 18 splits the light signal into two half power optical beam components which pass through two corresponding optical waveguide arms 20 and 22. An optical combiner 24 combines the two optical beam components from the arms to form an output light signal passing through the output optical waveguide section 14. A phase shifter 30 is provided for each optical waveguide arm 20 and 22. Each phase shifter 30 comprises a semiconductor structure, typically formed from a silicon layer 26 supported by an insulator 28 such as a buried oxide (BOX) layer, forming a PN junction 32 in a plane parallel the propagation axis of the optical waveguide arm. This structure is generally shown in the cross-section of FIG. 2 as including a p-type doped region 34 (including a p+region for the anode contact 36) and an n-type doped region 38 (including a cathode contact 40). A perspective view of one optical waveguide arm 20 or 22 is shown in FIG. 3. Each of the optical waveguides may be formed from the silicon layer 26 supported by the insulator 28 in the shape of an inverted “T” cross-section to include a central portion 42 which carries the optical beam. The thicker portion of the p-type doped region 34 aligned with the central portion 42 mainly carries the optical beam through the phase shifter 30.

To control operation of the phase shifters 30, a voltage is applied between the anode contact 36 and cathode contact 40. This applied voltage reverse biases the PN junction 32 causing a displacement of electrons from the n-type doped region 38 to the cathode contact 40 and a displacement of holes from the p-type doped region 34 to the anode contact 36. A depletion region is accordingly formed in the vicinity of the PN junction 32. The carrier concentration in the area of the thicker portion of the p-type doped region 34 that is crossed by the optical beam is thus modified in accordance with the magnitude of the bias voltage. A corresponding modification of the refractive index in this area occurs and this can be used to modulate the optical beam. A linear drive circuit 50 responsive to an input signal S generates drive signals for application to the phase shifters 30. The drive circuit 50 has a true signal output V 54 that drives the cathode contact 40 of one phase shifter 30a in the arm 20, a complement signal output V 56 which drives the cathode contact 40 of the other phase shifter 30b in the arm 22 and a ground signal output (GND) 58 which is connected to the anode contacts 36 of the two phase shifters 30. FIG. 1 illustrates an example of the V and V signals.

The phase shifters may alternatively have a configuration as shown in United States Patent Application Publication Nos. 2014/0341499 and 2014/0376852, incorporated herein by reference.

### SUMMARY

In an embodiment, an optical modulator comprises: an optical waveguide having an input and an output; a plurality of PN junction phase shifters, each PN junction phase shifter extending along a portion of said optical waveguide; a digital to analog converter configured to receive an n-bit input digital signal and output a pulse amplitude modulated (PAM) analog signal having 2ⁿ levels, where n is greater than or equal to 2; and a drive circuit having an input configured to receive said analog signal, said drive circuit comprising a plurality of drivers coupled in cascade, each driver configured to generate a drive signal in response to said PAM analog signal for controlling operation of a corresponding PN junction phase shifter.

In an embodiment, a method comprises: receiving an n-bit input digital signal; converting the n-bit input digital signal to a pulse amplitude modulated (PAM) analog signal having 2ⁿ levels, where n is greater than or equal to 2; generating from said PAM analog signal a plurality of drive signals; and applying each drive signal to PN junction phase shifter of an optical waveguide, each PN junction phase shifter extending along a portion of said optical waveguide.

In an embodiment, an optical modulator comprises: an optical waveguide having: an input waveguide; and an optical splitter to split the input waveguide into a first waveguide arm and a second waveguide arm, said first and second waveguide arms being parallel to each other; a first PN junction phase shifter positioned on the first waveguide arm; a second PN junction phase shifter positioned on the first waveguide arm; a third PN junction phase shifter positioned on the second waveguide arm parallel to the first PN junction phase shifter; a fourth PN junction phase shifter positioned on the second waveguide arm parallel to the third PN junction phase shifter; a digital to analog converter configured to receive an n-bit input digital signal and output a pulse amplitude modulated (PAM) analog signal having 2ⁿ levels, where n is greater than or equal to 2; a first driver having an input configured to receive the PAM analog signal and an output configured to generate first drive signals for application to control operation of the first and second PN junction phase shifters; and a second driver having an input configured to receive the first drive signals and an output configured to generate second drive signals for application to control operation of the third and fourth PN junction phase shifters.

### BRIEF DESCRIPTION OF THE DRAWINGS

For a better understanding, preferred embodiments thereof are now described, purely by way of non-limiting example, with reference to the attached drawings, wherein:

FIG. 1 is a schematic diagram of a prior art Mach-Zehnder Interferometer (MZI) type optical modulator;

FIG. 2 is a cross-section of a phase shifter for the MZI optical modulator of FIG. 1;

FIG. 3 is a perspective view of one optical waveguide arm for the MZI optical modulator of FIG. 1;

FIG. 4 is a schematic diagram of a MZI type optical modulator;

FIG. 4A shows the bit waveform;

FIG. 4B shows the waveform output after digital-to-analog conversion;

FIG. 4C shows waveform output from the driver circuits;

FIG. 5 is an exploded perspective view of a multi-chip solution for integration of the optical modulator of FIG. 4;

FIG. 6A is a cross-sectional view of the multi-chip solution;

FIGS. 6B and 6C show alternative configurations for the multi-chip solution;

FIG. 7 is a schematic diagram of a MZI type optical modulator; and

FIG. 8 is an exploded perspective view of a multi-chip solution for integration of the optical modulator of FIG. 7.

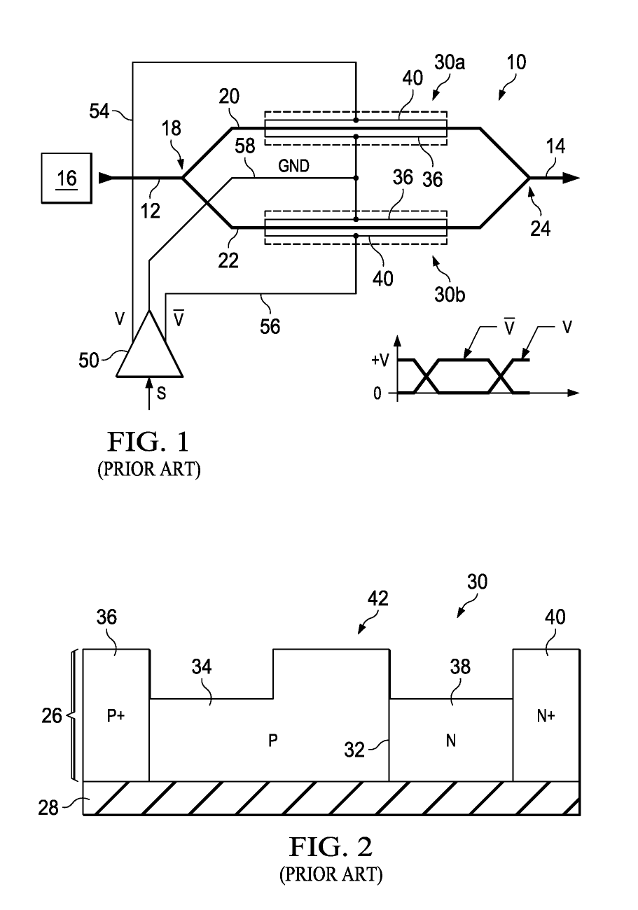

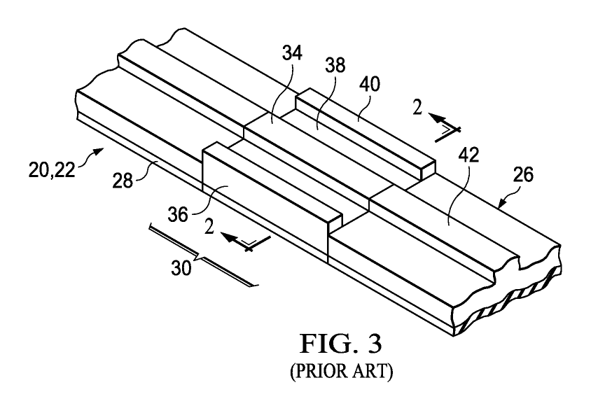

### DETAILED DESCRIPTION

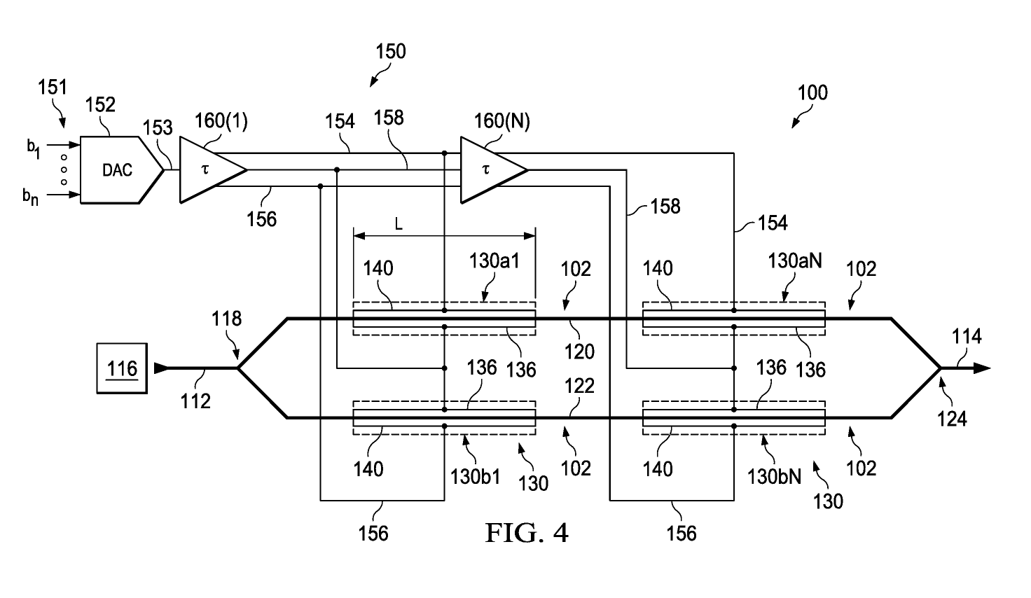

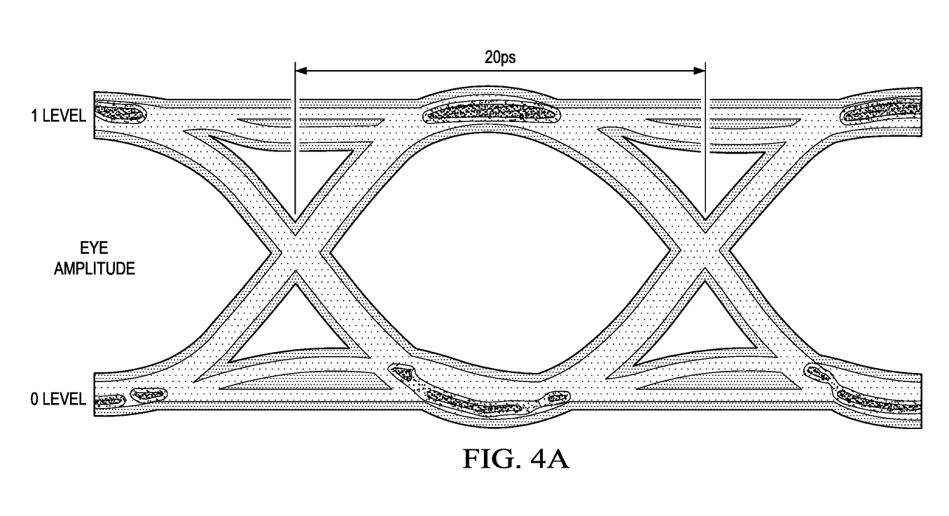

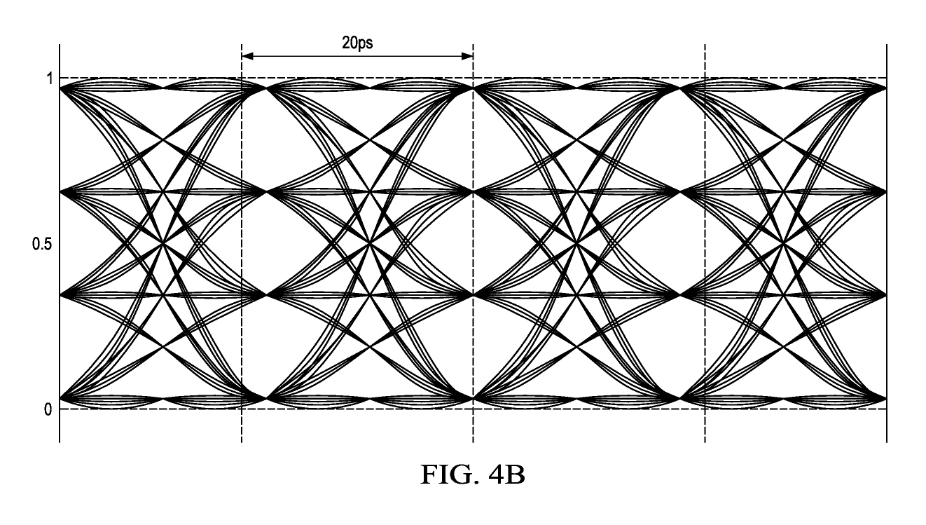

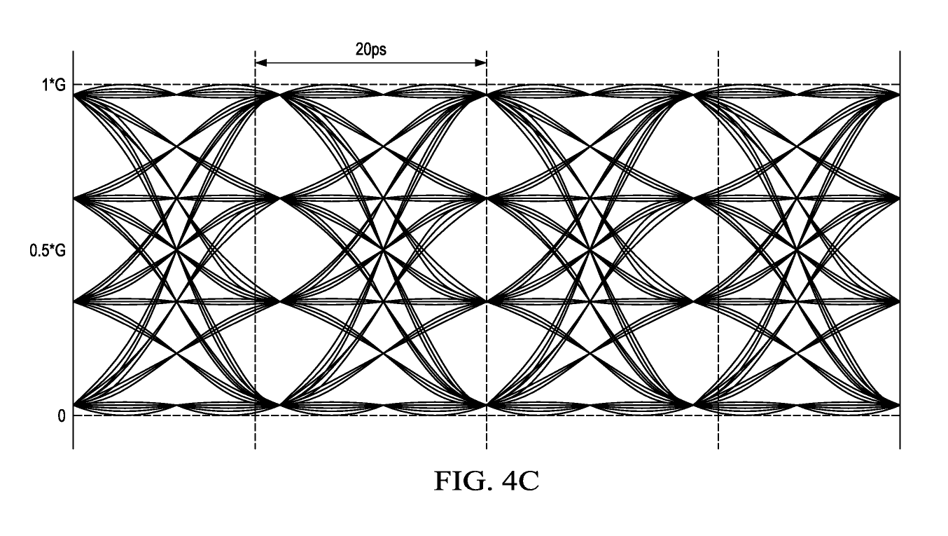

Reference is now made to FIG. 4 showing a schematic diagram of a Mach-Zehnder Interferometer (MZI) type optical modulator 100. The modulator 100 includes an input optical waveguide section 112 and an output optical waveguide section 114. A continuous wave (CW) light signal from a laser source 116 is coupled to the input optical waveguide section 112. An optical splitter 118 splits the light signal into two half power optical beam components which pass through two corresponding parallel optical waveguide arms 120 and 122. An optical combiner 124 combines the two optical beam components from the arms to form an output light signal passing through the output optical waveguide section 114. Each optical waveguide arm 120 and 122 includes a plurality of phase shifters 130, each phase shifter is included in a corresponding straight section 102 of the arm. The optical waveguide arm 120 may include N phase shifters 130a1 to 130aN and the optical waveguide arm 122 may include N phase shifters 130b1 to 130bN. FIG. 4 shows two (N=2) phase shifters 130 per optical waveguide arm 120 and 122, but this is understood to be an example only. The included phase shifters 130 may preferably each have a same length L along a direction of optical beam propagation, and each optical waveguide arm 120 and 122 is straight between the optical splitter 118 and the optical combiner 124.

Each phase shifter 130 comprises a semiconductor structure forming a PN junction. See, for example, the configuration shown in FIG. 2 and previously discussed. The PN junction is formed between a p-type doped region coupled to an anode contact 136 and an n-type doped region coupled to a cathode contact 140. To control operation of the phase shifters, a voltage is applied between the anode contact 136 and cathode contact 140. This applied voltage reverse biases the PN junction causing a displacement of electrons from the n-type doped region to the cathode contact 140 and a displacement of holes from the p-type doped region to the anode contact 136. A depletion region is accordingly formed in the vicinity of the PN junction. The carrier concentration in the area that is crossed by the optical beam is thus modified in accordance with the magnitude of the bias voltage. A corresponding modification of the refractive index in this area occurs and this can be used to modulate the optical beam.

A linear drive circuit 150 generates drive signals for application to each of the phase shifters 130. The drive circuit 150 is formed by a plurality of drivers (each with a delay τ) 160(1) to 160(N) coupled in cascade (series). Each driver 160 has a true signal output V 154 which drives the cathode contact 140 of a corresponding phase shifter 130a in one arm, a complement signal output V̅ 156 which drives the cathode contact 140 of a corresponding phase shifter 130b in another arm and a ground signal output (GND) 158 which is connected to the anode contacts 136 of the phase shifters 130a and 130b. The outputs 154, 156 and 158 of a given driver 160 are further coupled to the inputs of a next driver 160 in the cascade (series) connection.

If the lengths L of the phase shifters 130 are the same, it makes the computation of the delay T easier to compute. In the event the lengths L of the phase shifters 130 are not the same, adjustment of the computed delay τ at each driver 160 is needed to ensure proper modulation operation. In the illustrated implementation, the first driver 160 has a delay τ=0. The next driver 160 has non-zero delay τ calculated to compensate for the group velocity mismatch between the electrical signals propagating along the cascaded drivers 160 and the optical signals propagating along the waveguide arms 120, 122. A corresponding delay τ calculation is made for each driver 160 in the cascade connection.

The inputs of the first driver 160(1) are coupled to the outputs of a digital-to-analog converter (DAC) 152. The DAC 152 receives an n-bit signal 151 comprising bits b₁ to bₙ. The signal for each bit b may, for example, be output from a serializer circuit and have, for example, a 50 Gbaud data rate (i.e., one symbol=20 ps) as shown in FIG. 4A. The DAC 152 converts the received n bits into an analog signal 153 having 2ⁿ discrete voltage levels, where n is greater than or equal to 2. As an example, n=2 and the analog signal 153 output from the DAC 152 has 2²=4 levels (i.e., PAM-4 modulation) as shown in FIG. 4B. So, for example, if b1=1 and b2=0, the DAC converts “01” to a second of the four modulation levels. The analog signal 153 is applied to the input of the linear drive circuit 150 which uses the drivers (with delay τ) 160 coupled in cascade to generate the true signal output V 154 and complement signal output V̅ 156 for each phase shifter 130. These signals 154 and 156 will have a corresponding number of modulation levels (for example, four levels for the PAM-4 modulation) with magnitudes scaled by the gain G of the driver 160 (see, FIG. 4C).

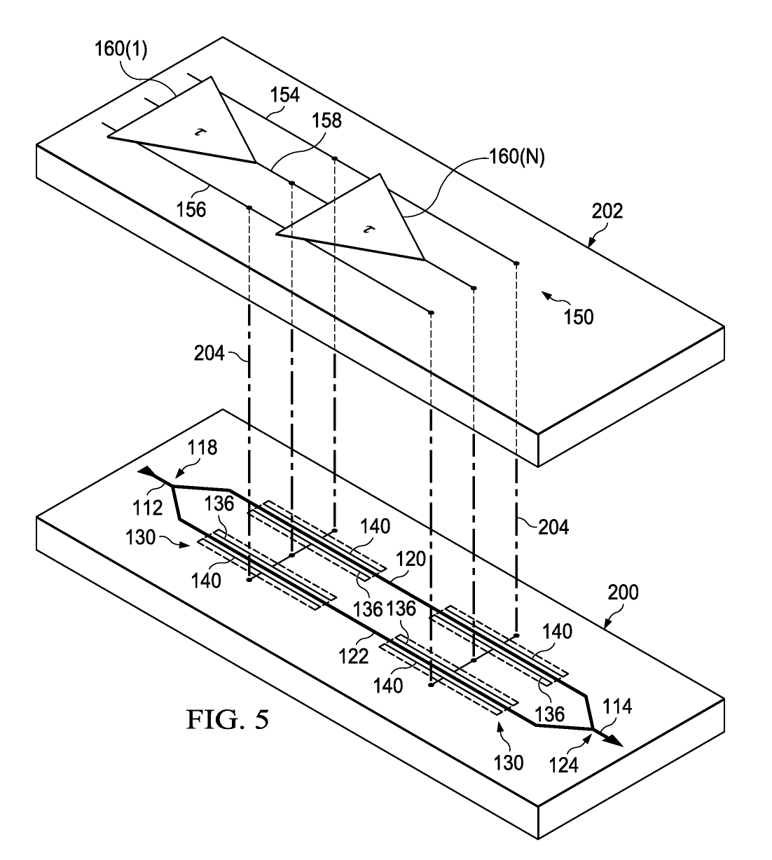

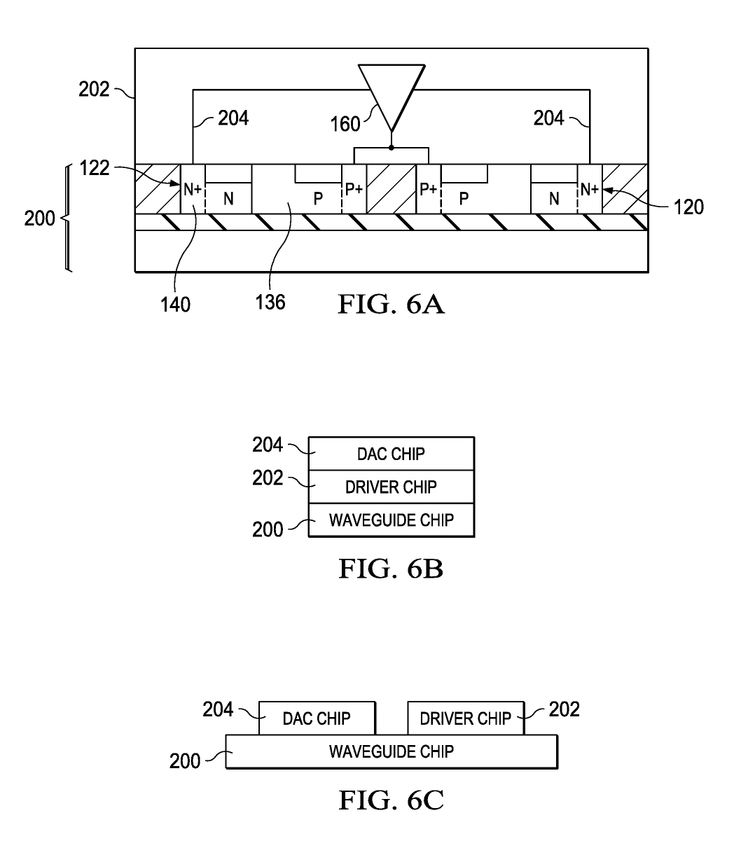

The modulator 100 may be fabricated as an integrated circuit device. In an embodiment, a multi-chip solution as shown in FIGS. 5 and 6A is used for the modulator. The multi-chip solution includes a first integrated circuit chip 200 within which the optical waveguide components (references 112, 114, 116, 118, 120, 122 and 124) and phase shifters 130 are formed. A second integrated circuit chip 202 includes the drive circuit 150 (and perhaps the DAC 152). The second integrated circuit chip 202 is stacked on top of the first integrated circuit chip 200 with the second integrated circuit chip 202 including electrical contacts 204 for making electrical connection to the anode contacts 136 and cathode contacts 140 of the phase shifters 130. The electrical contacts 204 may, for example, utilize a micro-copper pillar technology as known in the art.

FIG. 6B shows an alternative configuration for the multi-chip solution wherein the first integrated circuit chip 200 provides the waveguide circuit, the second integrated circuit chip 202 provides the driver circuits and is stacked on the first integrated circuit chip 200, and a third integrated circuit chip 204 provides the DAC (and perhaps serializer) circuits and is stacked on the second integrated circuit chip 202.

FIG. 6C shows an alternative configuration for the multi-chip solution wherein the first integrated circuit chip 200 provides the waveguide circuit, the second integrated circuit chip 202 provides the driver circuits and is stacked on the first integrated circuit chip 200, and the third integrated circuit chip 204 provides the DAC (and perhaps serializer) circuits and is stacked on the first integrated circuit chip 200.

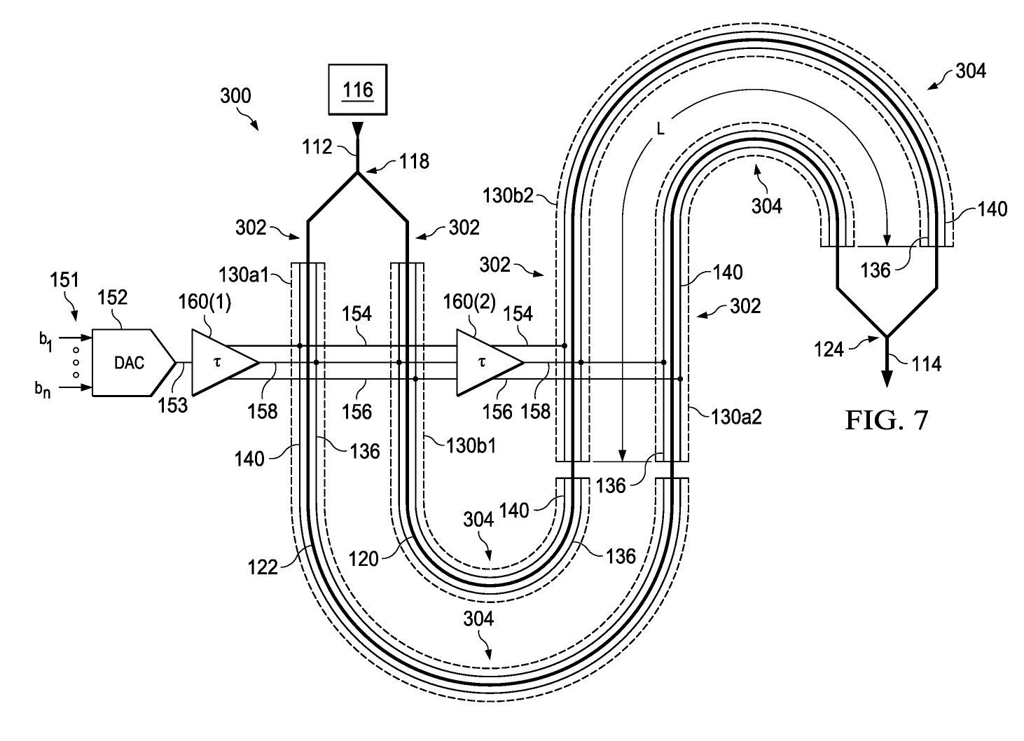

Reference is now made to FIG. 7 showing a schematic diagram of a MZI type optical modulator 300. The modulator 300 includes an input optical waveguide section 112 and an output optical waveguide section 114. A continuous wave (CW) light signal from a laser source 116 is coupled to the input optical waveguide section 112. An optical splitter 118 splits the light signal into two half power optical beam components which pass through two corresponding optical waveguide arms 120 and 122. An optical combiner 124 combines the two optical beam components from the arms to form an output light signal passing through the output optical waveguide section 114. Each optical waveguide arm 120 and 122 includes a plurality of phase shifters 130. The optical waveguide arm 120 may include N phase shifters 130a1 to 130aN and the optical waveguide arm 122 may include N phase shifters 130b1 to 130bN. FIG. 7 shows two (N=2) phase shifters 130 per optical waveguide arm 120 and 122, but this is understood to be an example only. The included phase shifters 130 may, for example, each have a same length L along a direction of optical beam propagation. Unlike with the implementation shown in FIG. 4, in the FIG. 7 implementation each optical waveguide arm 120 and 122 has a serpentine shape forming a bent optical path comprised of straight sections 302 and curved sections 304 which connect two straight sections 302. Furthermore, each phase shifter 130 includes a straight portion extending along the straight section 304 and a curved portion extending along the curved section 304. It is preferred that a length of the each straight section 302 be much less than the wavelength of the signal. Likewise, it is preferred that a length of the each curved section 304 be much less than the wavelength of the signal.

In this implementation, each curved section 304 curves the optical waveguide arm by 180°, but this is by way of example only. For example, 90° curves could instead be used. What is important is that over the overall length, the length of the arm 120 and the length of the arm 122 must be equal. This necessitates opposite direction bending of the curved sections as shown. The degree of a curve is not as important as ensuring in the design with the desired curves the same optical lengths for the two arms.

Each phase shifter 130 comprises a semiconductor structure forming a PN junction. See, for example, the configuration shown in FIG. 2 and previously discussed. The PN junction is formed between a p-type doped region coupled to an anode contact 136 and an n-type doped region coupled to a cathode contact 140. To control operation of the phase shifters, a voltage is applied between the anode contact 136 and cathode contact 140. This applied voltage reverse biases the PN junction causing a displacement of electrons from the n-type doped region to the cathode contact 140 and a displacement of holes from the p-type doped region to the anode contact 136. A depletion region is accordingly formed in the vicinity of the PN junction. The carrier concentration in the area that is crossed by the optical beam is thus modified in accordance with the magnitude of the bias voltage. A corresponding modification of the refractive index in this area occurs and this can be used to modulate the optical beam. A linear drive circuit 150, operating in response to the analog signal 153 output from the digital-to-analog converter (DAC) 152 receiving the n-bit signal 151, generates drive signals for application to each of the phase shifters 130. The linear drive circuit 150 is formed by a plurality of drivers (with delay τ) 160(1) to 160(N) coupled in cascade. Each driver 160 has a true signal output V 154 which drives the cathode contact 140 of a corresponding phase shifter 130a in one arm, a complement signal output V̅ 156 which drives the cathode contact 140 of a corresponding phase shifter 130b in another arm and a ground signal output (GND) 158 which is connected to the anode contacts 136 of the phase shifters 130a and 130b. The outputs 154, 156 and 158 of a given driver 160 are further coupled to the inputs of a next driver 160 in the cascade (series) connection. The inputs of the first driver 160(1) are coupled to the output of the DAC 152.

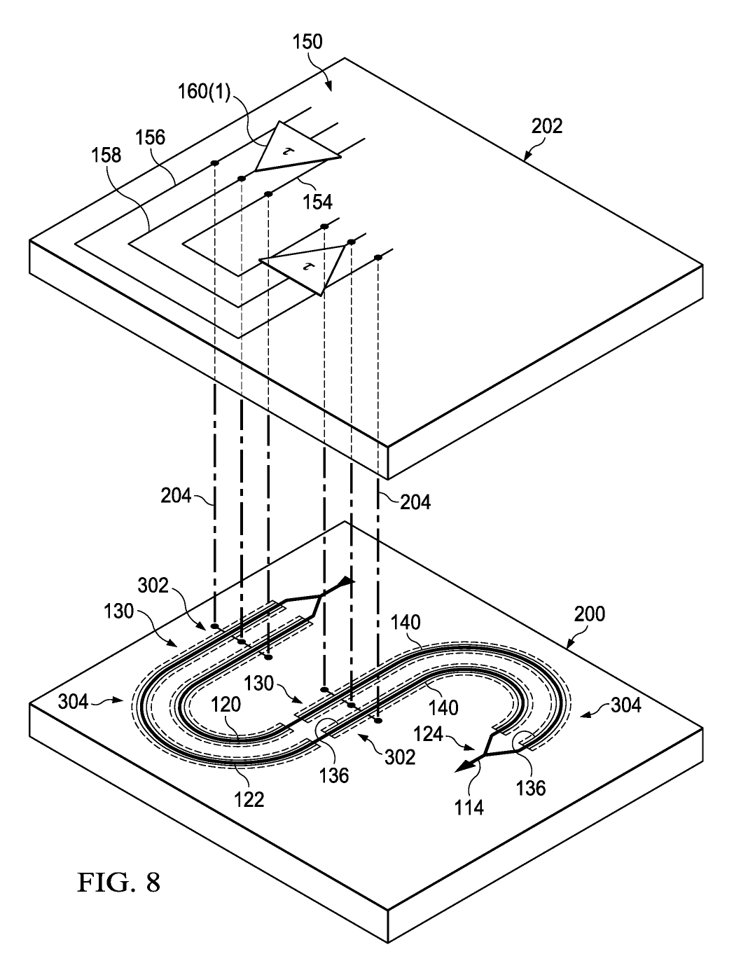

The modulator 300 may be fabricated as an integrated circuit device. In a preferred embodiment, a multi-chip solution as shown in FIGS. 6A and 8 is used for the modulator. The multi-chip solution includes a first integrated circuit chip 200 within which the optical waveguide components (references 112, 114, 116, 118, 120, 122 and 124) and phase shifters 130 are formed. A second integrated circuit chip 202 includes the drive circuit 150 (and perhaps the DAC 152). The second integrated circuit chip 202 is stacked on top of the first integrated circuit chip 200 with the second integrated circuit chip 202 including electrical contacts 204 for making electrical connection to the anode contacts 136 and cathode contacts 140 of the phase shifters 130. The electrical contacts 204 may, for example, utilize a micro-copper pillar technology as known in the art. The implementations shown in FIGS. 6B or 6C may alternatively be used.

The implementations described herein support high data rates. Additionally, a higher outer optical modulation amplitude means that there is a high extinction ratio. The implementations provide for a reduced complexity integrated circuit system. In addition, especially with the embodiment of FIG. 7, there is a reduction in occupied area as well as a reduction in the electrical modulation signal length. The entire length of the optical path can be made active, including with the phase shifter provided in the curved portions of the waveguide arms.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An optical modulator, comprising:
an optical waveguide having an input and an output;
a plurality of PN junction phase shifters, each PN junction phase shifter extending along a portion of said optical waveguide;
a digital to analog converter configured to receive an n-bit input digital signal and output a pulse amplitude modulated (PAM) analog signal having 2ⁿ levels, where n is greater than or equal to 2; and
a drive circuit having an input configured to receive said analog signal, said drive circuit comprising a plurality of drivers coupled in cascade, each driver configured to generate a drive signal in response to said PAM analog signal for controlling operation of a corresponding PN junction phase shifter.

2. The optical modulator of claim 1, wherein each PN junction phase shifter has a same length.

3. The optical modulator of claim 1, wherein each portion of said optical waveguide comprises a straight section that is connected in series with a curved section and wherein each PN junction phase shifter comprises a first straight PN junction portion extending along the straight section and a first curved PN junction portion extending along the curved section.

4. The optical modulator of claim 3, wherein the curved section curves the optical waveguide by 180°.

5. The optical modulator of claim 1,
wherein the optical waveguide and the each PN junction phase shifter are fabricated on a first integrated circuit chip;
wherein the drive circuit is fabricated on a second integrated circuit chip; and
wherein the second integrated circuit chip is stacked over the first integrated circuit chip.

6. The optical modulator of claim 5, further comprising circuit routing for electrically interconnecting the drivers of the drive circuit on the second integrated circuit chip to each of the plurality of PN junction phase shifters on the first integrated circuit chip.

7. The optical modulator of claim 1, further comprising:
an additional optical waveguide having an input and an output;
a plurality of additional PN junction phase shifters, each additional PN junction phase shifter extending along an additional portion of said additional optical waveguide;
wherein the optical waveguide and additional optical waveguide are parallel to each other.

8. The optical modulator of claim 7, wherein each driver is further configured to generate an additional drive signal in response to said analog signal for controlling operation of a corresponding additional PN junction phase shifter.

9. The optical modulator of claim 7, wherein the inputs of the optical waveguide and additional optical waveguide are coupled to an optical splitter and wherein the outputs of the optical waveguide and additional optical waveguide are coupled to an optical combiner.

10. The optical modulator of claim 7,
wherein the optical waveguide, additional optical waveguide, each PN junction phase shifter and each additional PN junction phase shifter are fabricated on a first integrated circuit chip;
wherein the drive circuit is fabricated on a second integrated circuit chip; and
wherein the second integrated circuit chip is stacked over the first integrated circuit chip.

11. The optical modulator of claim 10, further comprising circuit routing for electrically interconnecting the drivers of the drive circuit on the second integrated circuit chip to each of the plurality of PN junction phase shifters and additional PN junction phase shifters on the first integrated circuit chip.

12. The optical modulator of claim 1, wherein said plurality of drivers comprise:
a first driver configured to generate a first drive signal in response to said PAM analog signal; and
a second driver configured to generate a second drive signal in response to said first drive signal;
wherein said first drive signal is applied to a first PN junction phase shifter of the optical waveguide and said second drive signal is applied to a second PN junction phase shifter of the optical waveguide, said first and second PN junction phase shifters positioned consecutively along the optical waveguide.

13. The optical modulator of claim 12, wherein said second driver is configured to delay the first drive signal before generating the second drive signal from said first drive signal.

14. A method, comprising:
receiving an n-bit input digital signal;
converting the n-bit input digital signal to a pulse amplitude modulated (PAM) analog signal having 2ⁿ levels, where n is greater than or equal to 2;
generating from said PAM analog signal a plurality of drive signals; and
applying each drive signal to PN junction phase shifter of an optical waveguide, each PN junction phase shifter extending along a portion of said optical waveguide.

15. The method of claim 14, wherein each PN junction phase shifter has a same length.

16. The method of claim 14, wherein generating comprises:
generating a first drive signal in response to said PAM analog signal; and
generating a second drive signal in response to said first drive signal;
wherein said first drive signal is applied to a first PN junction phase shifter of the optical waveguide and said second drive signal is applied to a second PN junction phase shifter of the optical waveguide, said first and second PN junction phase shifters positioned consecutively along the optical waveguide.

17. The method of claim 16, wherein generating the second drive signal comprises delaying the first drive signal before generating the second drive signal from said first drive signal.

18. The method of claim 14, wherein each portion of said optical waveguide comprises a straight section that is connected in series with a curved section and wherein each PN junction phase shifter comprises a first straight PN junction portion extending along the straight section and a first curved PN junction portion extending along the curved section.

19. The method of claim 18, wherein the curved section curves the optical waveguide by 180°.

20. An optical modulator, comprising:
an optical waveguide having:
an input waveguide; and
an optical splitter to split the input waveguide into a first waveguide arm and a second waveguide arm, said first and second waveguide arms being parallel to each other;
a first PN junction phase shifter positioned on the first waveguide arm;
a second PN junction phase shifter positioned on the first waveguide arm;
a third PN junction phase shifter positioned on the second waveguide arm parallel to the first PN junction phase shifter;
a fourth PN junction phase shifter positioned on the second waveguide arm parallel to the third PN junction phase shifter;
a digital to analog converter configured to receive an n-bit input digital signal and output a pulse amplitude modulated (PAM) analog signal having 2ⁿ levels, where n is greater than or equal to 2;
a first driver having an input configured to receive the PAM analog signal and an output configured to generate first drive signals for application to control operation of the first and second PN junction phase shifters; and
a second driver having an input configured to receive the first drive signals and an output configured to generate second drive signals for application to control operation of the third and fourth PN junction phase shifters.

21. The optical modulator of claim 20, wherein the first, second, third and fourth PN junction phase shifters have a same length and extend along a corresponding waveguide portion.

22. The optical modulator of claim 20, wherein each waveguide portion comprises a straight waveguide section that is connected in series with a curved waveguide section and wherein each PN junction phase shifter comprises a first straight PN junction portion extending along the straight waveguide section and a first curved PN junction portion extending along the curved waveguide section.

23. The optical modulator of claim 22, wherein the curved section curves the optical waveguide by 180°.

24. The optical modulator of claim 20,
wherein the optical waveguide and the each PN junction phase shifter are fabricated on a first integrated circuit chip;
wherein the first and second drivers are fabricated on a second integrated circuit chip; and
wherein the second integrated circuit chip is stacked over and electrically connected to the first integrated circuit chip.

25. The optical modulator of claim 20, wherein said second driver is configured to delay the first drive signal before generating the second drive signal from said first drive signal.
